(19) United States
(12) Patent Application Publication
(10) Pub. No.: US 2026/0341858 A1
(43) Pub. Date: Oct. 29, 2026

(54) A CYLINDRICAL SECONDARY CELL COMPRISING AN INCLINED ENCLOSURE AND A LID

(71) Applicant: Northvolt AB, Stockholm (SE)

(72) Inventors: Kenya Shatani, Stockholm (SE); Michael Shaughnessy, Västerås (SE)

(21) Appl. No.: 19/107,441

(22) PCT Filed: Aug. 28, 2023
(86) PCT No.: PCT/EP2023/073522

§ 371 Date: Feb. 27, 2025

(30) Foreign Application Priority Data
Aug. 31, 2022 (SE) 2251011-9

(51) Int. Cl. H01M 50/152; H01M 10/04; H01M 50/107; H01M 50/169; H01M 50/179; H01M 50/342; H01M 50/531

(52) U.S. Cl. CPC H01M 50/152; H01M 10/0431; H01M 50/107; H01M 50/169; H01M 50/179; H01M 50/3425; H01M 50/531; H01M 2200/20

(57) ABSTRACT

This disclosure presents a cylindrical secondary cell (1) comprising a cylindrical enclosure (2) comprising a first enclosure end (2a), a second enclosure end (2b) and an enclosure sidewall (2c) extending between the enclosure ends (2a, 2b), wherein at least one enclosure end (2b) is open. The cell (1) further comprises a lid (10) to be attached radially internally to the cylindrical enclosure (2) at the open enclosure end (2b). An end section (2ce) at the open enclosure end (2b) of the enclosure sidewall (2c) extends non-parallel to the remaining enclosure sidewall (2c). The lid (10) comprises a flange (10f) that, when attached to the cylindrical enclosure (2), extends non-parallel to the enclosure sidewall (2c) to match the end section (2ce). Further, a method of manufacturing a cylindrical secondary cell is presented.

### TECHNICAL FIELD

The present disclosure generally pertains to cylindrical secondary cells and more precisely to a cylindrical secondary cell having an enclosure with an open end to which a lid is attached.

### BACKGROUND

In addressing climate change, there is an increasing demand for rechargeable batteries, e.g. to enable electrification of transportation and to supplement renewable energy. Currently, lithium-ion batteries are becoming increasingly popular. They represent a type of rechargeable battery in which lithium ions move from the negative electrode to the positive electrode during discharge and back when charging.

As the demand for rechargeable batteries increases, more and more focus is being placed on production speed and cost. To achieve an effective production of rechargeable batteries, the design of the batteries as well as their manufacturing process can be optimized.

Another aspect to consider is that the rechargeable batteries must be safe to use. Therefore, rechargeable batteries have at least one vent for releasing gas when the pressure inside the batteries rises above an allowed level.

A rechargeable battery, often referred to as a secondary battery, typically comprises one or more secondary cells electrically connected to each other.

### SUMMARY

It is in view of the above considerations and others that the embodiments of the present invention have been made. The present disclosure aims at providing highly reliable secondary cells that are efficient in manufacture. The number of components is to be reduced and the assembly thereof is to be simplified.

According to one aspect of the present disclosure, a cylindrical secondary cell is provided. The cylindrical secondary cell comprises
a cylindrical enclosure comprising a first enclosure end, a second enclosure end and an enclosure sidewall extending between the enclosure ends, wherein at least one enclosure end is open, and
a lid to be attached radially internally to the cylindrical enclosure at the open enclosure end,
   wherein
an end section at the open enclosure end of the enclosure sidewall extends non-parallel to the remaining enclosure sidewall, and
the lid comprises a flange that, when attached to the cylindrical enclosure, extends non-parallel to the enclosure sidewall to match the end section.

The lid may be configured to be arranged in direct electrical contact with an electrode roll that is arranged inside the cylindrical enclosure. The lid alone may thus provide an electrical contact between the electrode roll and the cylindrical enclosure.

The lid may be arranged radially and axially within the cylindrical enclosure, or at least not protrude radially or axially from the cylindrical enclosure. The end section and the flange may both be inclined with respect to a longitudinal direction of the cylindrical secondary cell. The end section and the flange may be inclined such that they match one another and a large contact surface there between is obtained.

According to another aspect of the present disclosure, a method of attaching the above-described lid to the above-described cylindrical enclosure is provided. The method comprises positioning a weld where the end section meets the flange. In other words, the weld is positioned at a weld interface between the end section and the flange.

Positioning the weld may comprise optically scanning the enclosure end and the lid to automatically position the weld with a high accuracy. The scanning may be facilitated by the weld interface being at least partly visible. In addition, with such a weld interface the weld may be visually inspected after welding.

A laser beam that forms the weld may for example be substantially aligned with the extension of the end section. The laser beam may extend in parallel with the end section. In another example, the laser beam is substantially orthogonal to the end section. During welding, the cylindrical secondary cell may be rotated around its longitudinal axis.

Advantages associated with the present disclosure, and additional conceivable features, will become clear from the following description of embodiments and examples.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings, in which

FIG. 1 schematically illustrates a cylindrical secondary, comprising a cylindrical enclosure and a lid, cell in cross-section,

FIG. 2 is an enlarged view of the encircled area of FIG. 1,

FIG. 3 discloses an alternative embodiment to the one of FIG. 2,

FIG. 4 shows a lid of the cylindrical secondary cell of FIG. 1 in more detail, and

FIG. 5 illustrates methods of attaching the lid of FIG. 1 to the cylindrical enclosure.

### DETAILED DESCRIPTION

Embodiments of the present disclosure will now be described more fully hereinafter. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art.

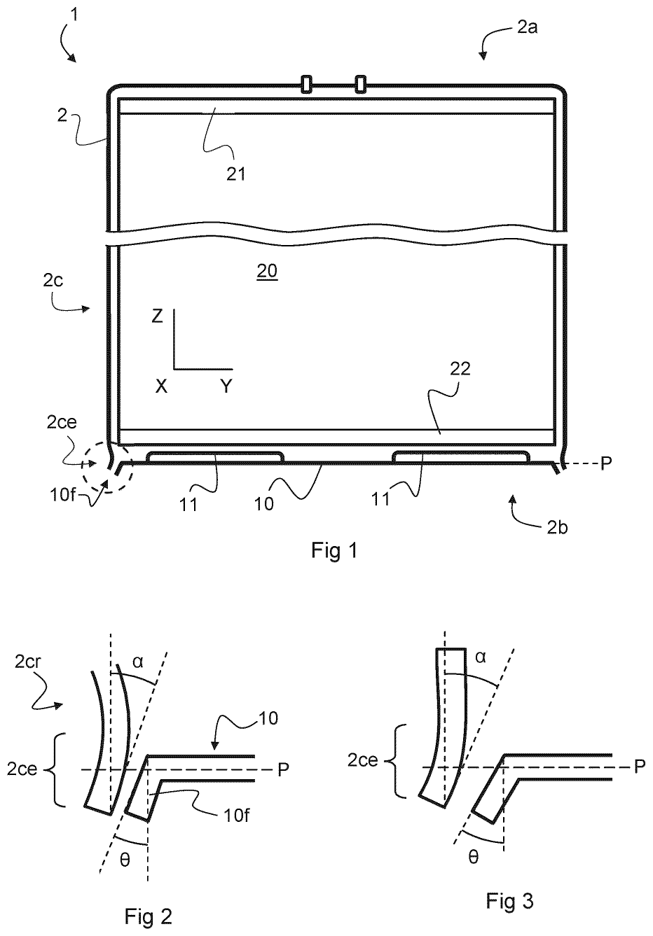

FIG. 1 shows a cylindrical secondary cell 1 (hereinafter referred to as cell) in a cross-sectional side view. In the exemplified embodiment, the cell 1 is circular cylindrical. The cell 1 comprises a cylindrical enclosure 2 having a first enclosure end 2a, an opposite second enclosure end 2b and an enclosure sidewall 2c that extends between the enclosure ends 2a, 2b.

In the exemplified embodiment, the first and second enclosure ends 2a, 2b are circular. The enclosure sidewall 2c is circular cylindrical. The cell 1, and thus its enclosure sidewall 2c, may be elongate and extend along a longitudinal axis (Z-axis in FIG. 1). The enclosure ends 2a, 2b may extend in planes (XY-planes in FIG. 1) that are perpendicular to the longitudinal axis.

As is illustrated, the first enclosure end 2a, or first enclosure end side (top side in FIG. 1), may be closed and formed in one piece with the enclosure sidewall 2c. The second enclosure end 2b may be open and a separate lid 10 may, as shown, be attached radially internally to the cylindrical enclosure 2 at the open enclosure end 2b. Thus, the lid 10 may form the second enclosure end side (bottom side in FIG. 1). Alternatively, both ends sides may be formed by respective lids.

In typical embodiments, as is illustrated in FIG. 1, the main portion of the enclosure sidewall 2c is essentially straight. The main portion of the enclosure sidewall 2c extends in parallel with the longitudinal axis (Z-axis in FIG. 1) of the cell 1. For example, the main portion of the enclosure sidewall 2c may be defined as at least 80 percent of the enclosure sidewall 2c extension along the longitudinal axis.

In the present embodiments, see FIGS. 1 to 3, an end portion 2ce, or end section, of the enclosure sidewall 2c is not straight (as seen in axial cross-section, FIGS. 1-3). The end section 2ce of the enclosure sidewall 2c extends non-parallel to the remaining enclosure sidewall 2c. The end section 2ce of the enclosure sidewall 2c may extend non-parallel to the main portion of the enclosure sidewall 2c. The end section 2ce of the enclosure sidewall 2c extends non-parallel to the longitudinal axis (Z-axis in FIG. 1) of the cell 1. In other words, the end section 2ce is inclined in relation to the remaining enclosure sidewall 2c.

The enclosure sidewall end section 2ce may be the section of the enclosure sidewall 2c that extends axially beyond (below in FIG. 1) the below-described electrode roll 20. The enclosure sidewall end section 2ce may be defined as the ultimate portion of the enclosure sidewall 2c, at the open end 2b of the latter. The enclosure sidewall end section 2ce may constitute the ultimate few percent, such as the ultimate 10 percent, or ultimate 5 percent, of the enclosure sidewall 2c at its open end 2b.

The enclosure sidewall 2c may at its open end 2b (lower end in the FIGS. 1-3, upper end in FIG. 5) extend at an angle α to the longitudinal axis of the cell 1. In other words, the enclosure sidewall end section 2ce may extend at an angle α to the longitudinal axis of the cell 1. Said angle may be referred to as an end section angle α. The end section angle α may result from the manufacturing of the enclosure 2.

The enclosure sidewall end section 2ce may be, but must not be, curved (as seen in axial cross-section, FIGS. 1-3 and 5). A curved element or line may possibly not be considered as extending at an angle. It may therefore be appropriate to define the enclosure sidewall end section 2ce as essentially extending at an angle α to the longitudinal axis of the cell 1. In any case, the enclosure sidewall end section 2ce, also when curved, extends non-parallel to the longitudinal axis of the cell 1 (and to the main portion of the enclosure sidewall 2c).

During assembly, the lid 10 may be held or clamped towards the inner surface of the enclosure sidewall end section 2ce and simultaneously be secured thereto by welding, typically laser welding.

FIGS. 2 and 3 better illustrate the attachment interface between the lid 10 and the cylindrical enclosure 2, i.e. the encircled area of FIG. 1. If the lid 10 is attached to be end section 2ce by welding, the attachment interface may be referred to as a weld interface 30, indicated in FIG. 5. FIG. 2 discloses an embodiment identical to that of FIG. 1, where the end section 2ce extends from a reduced radius section 2cr of the enclosure sidewall 2c. In other words, as is shown in FIG. 1, the enclosure sidewall 2c is S-shaped at the open enclosure end 2b. More precisely, the enclosure sidewall 2c comprises a local radius reduction at the open enclosure end 2b.

Now, in order to securely attach the lid 10 to the enclosure sidewall end section 2ce, the lid 10 comprises a flange 10f that extends non-parallel to the longitudinal axis of the cell 1 (and to the main portion of the enclosure sidewall 2c). The flange 10f may extend at an angle θ to the to the enclosure sidewall 2c. Said angle may be referred to as a flange angle θ. As is illustrated in FIGS. 1 and 2, the end section 2ce and the flange 10f may both extend at the same, or essentially the same, angles α, θ to the to the enclosure sidewall 2c. In other words, the extension of the flange 10f matches the end section 2ce. The flange 10f and the end section 2ce are both inclined. In this way, a relatively large contact surface may be obtained, which ensures a highly reliable attachment between cylindrical enclosure 2 and the lid 10 e.g. by a subsequently arranged weld.

Turning now to FIG. 3, an alternative embodiment of the enclosure sidewall 2c is illustrated. Here, the enclosure sidewall 2c does not comprise any reduced radius section 2cr. Again, the lid flange 10f that extends non-perpendicular to the enclosure sidewall 2c matches the end section 2ce and a highly reliable attachment between the cylindrical enclosure 2 and the lid 10 may be achieved, e.g. by welding.

The end section angle α, and the flange angle θ, may be in the range of 5 to 80 degrees. In the embodiment of FIG. 2, the angles α, θ are approximately 20 degrees. More precisely, the end section angle α is approximately 20 degrees and the flange angle θ is 23 degrees. Thus, the end section angle α essentially equals the flange angle θ. The angle deviation of FIG. 2, approximately 20 vs 23 degrees, ensures a secure attachment between the enclosure sidewall end section 2ce and the flange 10f.

In the embodiment of FIG. 3, the end section angle α is approximately 23 degrees and the flange angle θ is 30 degrees. Thus, the end section angle α matches the flange angle θ. The angle deviation of FIG. 3, approximately 23 vs 30 degrees, still ensures a secure attachment between the enclosure sidewall end section 2ce and the flange 10f.

The flange 10f is preferably attached, or secured, to the end section 2ce by welding. Typically, there is no other attachment between the lid 10 and the cylindrical enclosure 2. Thus, the lid 10 may be attached to the cylindrical enclosure 2 solely by the attachment between the flange 10f of the lid 10 and the end section 2ce of the cylindrical enclosure 2. Thus, no additional separate component, or manufacturing steps, are required for attaching the lid 10 to the cylindrical enclosure 2. Also, the direct attachment of the lid 10 to the cylindrical enclosure 2 may increase the usable volume inside the cylindrical secondary cell 1.

During welding, a curved or convex end section 2ce and/or flange 10f may at least partly melt and thus a relatively large contact surface, and strong weld connection, may be attained.

The cylindrical enclosure 2 thus provides an inner attachment surface to which an outer attachment surface of the lid 10 is attached. The inner attachment surface is provided by the inner surface of the end section 2ce. The outer attachment surface is provided by the outer surface of the flange 10f. The attachment interface between said inner and outer surfaces may be the only attachment interface between the cylindrical enclosure 2 and the lid 10. The end section 2ce and the flange 10f may have essentially the same extension (or length).

FIG. 5 illustrates the flange 10f being attached to the end section 2ce by welding. During assembly, the open end open end 2b of the cylindrical enclosure 2 may be oriented upwards, as is the case in FIG. 5. As is illustrated (top right laser head in FIG. 5), the laser beam may be aligned with the end section 2ce. In the present example, the laser beam extends in parallel with the end section 2ce. Thus, the laser beam may extend substantially aligned with, or fully aligned with, the above-defined end section angle α.

As is illustrated in FIGS. 1 to 3 and 5 the flange 10f and the end section 2ce may extend essentially in parallel. In practise, a certain deviation may acceptable as such deviation may be reduced or eliminated by a deformation, bending, of the flange 10f and/or of the end section 2ce by clamping the lid 10 towards the cylindrical enclosure 2 during welding. A certain deviation may further be accepted as the flange 10f and the end section 2ce may at least partially melt during welding, such that a large weld interface is obtained. As is also illustrated, the extension or length of the end section 2ce may be substantially equal to the extension or length of the flange 10f, which may be beneficial for maximising the usable volume inside the cylindrical secondary cell 1. The entire end section 2ce may be welded to the flange 10f, in order to securely attach the end section 2ce to the flange 10f. The entire flange 10f may be welded to the end section 2ce, in order to securely attach the flange 10f to the end section 2ce. The entire end section 2ce may be welded to the entire flange 10f, in order to securely attach the end section 2ce and the flange 10f to one another.

As illustrated, the weld interface 30 between the end section 2ce and the flange 10f may be at least partly visible. In the example of FIG. 5, the weld interface is at least partly visible from the outside of the cylindrical secondary cell 1. A visible weld interface may be visually inspected after welding to ensure a good weld quality. Further, a visible weld interface may be beneficial as it may facilitate automated welding, wherein the weld interface may be optically scanned to position the weld. A computer-controlled apparatus may both optically scan the weld interface and accurately perform the welding. During welding, the cylindrical secondary cell 1 may be rotated, or the welding apparatus may be moved.

The dimensions and orientations of the flange 10f and of the end section 2ce may thus be configured to simplify welding and provide a secure weld.

As is also illustrated (rightmost and leftmost laser heads) in FIG. 5, the laser beam(s) may be substantially orthogonal to the end section 2ce. As is apprehended from FIG. 5, depending on the selected position of the weld interface using a laser head with such a position, the weld interface may or may not be visible from the outside of the cylindrical secondary cell 1.

As is illustrated in FIG. 1, the cell 1 may be configured such that the lid 10 does not protrude radially beyond the cylindrical enclosure 2. This may be beneficial as a great number of cells 1 are typically arranged next to one another or in a holder structure in a secondary battery. In this connection, a protruding lid may impede an assembly process or a tight arrangement of cells. Also, the cell 1 may be configured such that the lid 10 does not protrude axially beyond the cylindrical enclosure 2. The lid 10 may be arranged both radially and axially internally of the cylindrical enclosure 2.

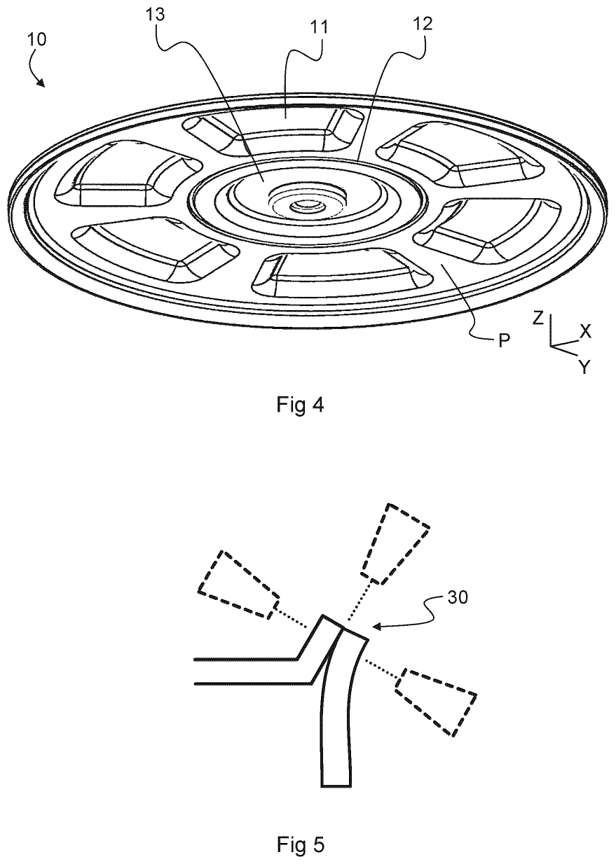

Referring to FIGS. 1 and 4, the lid 10 may be one-piece. As is also illustrated, the lid 10 may form a continuous surface that closes the cylindrical enclosure 2. In other words, the lid 10 may be gas-tight.

FIG. 1 illustrates a cell 1 of a type that has both a positive terminal and a negative terminal at one and the same end 2a (the top end in FIG. 1) of the cylindrical secondary cell 1. The first enclosure end 2a comprises a central terminal through-hole for the positive terminal. The negative terminal is electrically connected to the cylindrical enclosure 2. More precisely, the negative terminal is formed by the top surface of the cylindrical enclosure 2 that surrounds the terminal through-hole. Thus, the entire cylindrical enclosure 2 (apart from the positive terminal at the top end) may be the negative terminal.

A cell 1 having both terminals at one end may bring advantages as regards electrically connecting the cell to a load. Conductors electrically connecting the terminals to the load may be positioned on the same end, the terminal end (top side in FIG. 1), of the cell. The opposite end, which may be referred to as the electrolyte-filling end (bottom end in FIG. 1), of the cell 1 may be dedicated to electrolyte filling and venting. An overpressure may be generated within the cell during operation, in particular upon malfunction of the cell or of the load connected to the cell. Such malfunction may require a release of gas and/or other ejecta out of the cell, and it may be advantageous to direct the released gas and/or other ejecta away from the conductors, i.e. at the end opposite to the terminal end.

A number of cells 1 may be positioned at a low position in an electric vehicle. The cells 1 may be arranged with the terminal ends directed upwards and the electrolyte-filling ends (bottom end in FIG. 1) directed downwards. Upon malfunction, for example resulting from a faulty electric vehicle charger or a faulty cell 1, a release of gas and/or other ejecta from the electrolyte-filling end(s) will be advantageously directed downwards towards the ground beneath the vehicle. In other applications than vehicles, the electrolyte-filling ends may be directed towards a desired location such that any gas and/or other ejecta will not cause damages or injuries.

As is illustrated in FIG. 1, the cell 1 may comprise an electrode roll 20. The electrode roll 20 comprises a first and a second rolled conductive sheet 21, 22 and separating means (not shown). The separating means may also be termed separator. The conductive sheets 21, 22 and the separating means are rolled to form a circular cylindrical roll. The conductive sheets 21, 22 are coated with electrode coatings and on assembly of the cell 1, the cylindrical enclosure 2 is filled with an electrolyte. The coatings on the conductive sheets 21, 22 act as cathode and anode, respectively. The cathode, anode and electrolyte provide electrochemical energy storage. This principle is known per se, and the electrode roll 20 is commonly referred to as a jellyroll.

The rolled conductive sheets 21, 22 of the electrode roll 20 may be axially offset in relation to one another, and each conductive sheet may comprise an end section that is not coated with electrode coating. Via the non-coated end sections, the respective ends of the electrode roll may be efficiently electrically connected to a respective assigned terminal of the cell 1. This design is known per se and commonly referred to as a tabless cell.

As is illustrated in FIG. 1, one 22 of the rolled conductive sheets may be in electrical contact, more precisely in direct electrical contact, with the lid 10. Direct electrical contact may be referred to as physical contact.

Turning to FIG. 4, the lid 10 may be configured to be arranged in direct electrical contact with the rolled conductive sheet 22. Typically, the lid 10 is welded, e.g. laser welded, to the conductive sheet 22. Thus, no additional separate component needs to be arranged to make contact with the rolled conductive sheet 22.

As is shown in FIG. 4, and also in FIG. 1, the lid 10 may comprise at least one recessed contact portion 11 that is configured to form the direct electrical contact with the rolled conductive sheet 22. Typically, the above-mentioned weld is arranged within the at least one recessed contact portion 11.

Furthermore, the lid 10 may, as is shown in FIG. 4, comprise a groove or notch 12 for providing an opening in the lid 10 if a pressure to which the lid 10 is subjected, i.e. a pressure inside the cylindrical enclosure 2, reaches a threshold value. In such a situation, gas and/or other ejecta may be released out of the cell 1 through the opening formed in the lid 10. The opening formed in the lid 10 as a result of the notch 12 breaking may be referred to as a vent opening.

The groove or notch 12, which may be referred to as a breakable portion, may be a thinning of the lid material that is configured to break before other parts of the lid 10 (and the cylindrical enclosure 2). The notch 12 may be circular and may at least partly encircle a central portion of the lid 10.

The lid 10 may comprise a filling opening for the above-described electrolyte filling. The filling opening may be arranged in a recessed filling portion 13, as is shown in FIG. 4. The recessed filling portion 13 may be arranged in the same plane as the recessed contact portion 11. The filling opening may, as is shown, be sealed by a sealing element such as for example a rivet, such as a blind rivet. If the filling portion 13 is recessed, the sealing element may be countersunk such that it does not protrude beyond the enclosure end to which the lid 10 is attached.

The lid 10 may be generally disc-shaped. The lid 10 may have the general shape of a circular plate that extends in the below defined base plane P. In some more detail, the lid 10 may comprise a circular disc that at the radially outer end comprises the above-described flange 10f. The flange 10f may extend from the circular disc in a direction away from the cylindrical enclosure 2 (when the lid 10 is attached to the cylindrical enclosure 2). The circular disc and the flange 10f may be formed in one integral piece.

The recessed contact portion 11 or portions (there are six recessed contact portions 11 in the present embodiment) may be formed in the circular disc that extends in the below defined base plane P. The recessed contact portions 11 may be equidistantly distributed along the circumference of the lid 10. Each one of the recessed contact portions 11 may be of the same size. The recessed contact portions 11 may have essentially the same extension radially and circumferentially to facilitate welding. In other words, the recessed contact portions 11 may have similar extensions in all direction as seen in the plane (XY-plane in FIG. 1) of the lid. The smallest extension of the recessed contact portions 11 may be at least 20 percent of the total extension of the lid 10.

As is denoted in FIGS. 1 to 4, the lid 10 may comprise a base plane P. The base plane P may alternatively be referred to as a neutral plane or an axially central plane. The flange 10f, the illustrated recessed contact portions 11 and the illustrated recessed filling portion 13 may protrude axially from the base plane P. Referring in particular to FIG. 1, when the lid 10 is attached to the cylindrical enclosure 2, the base plane P of the lid 10 may be substantially aligned with the enclosure sidewall end section 2ce. Thus, only the optional recessed contact portions 11 (FIG. 1) and the optional recessed filling portion 13 (FIG. 4) may extend into the cylindrical enclosure 2 beyond the end section 2ce. In the present examples, the lid 10 is substantially axially aligned with the end section 2ce which may maximise the usable volume of the cylindrical secondary cell 1.

The enclosure sidewall 2c, or at least the enclosure sidewall end section 2ce, may have a constant material thickness.

In FIGS. 1 to 3 and 5, the material thickness of the cell 1 and the lid 10 have been exaggerated to elucidate the features of the present disclosure. For the same reason, FIGS. 1 to 3 illustrate a certain gap between the cylindrical enclosure 2 and the lid 10. It is to be apprehended that in actual implementations the lid 10 is brought in direct contact with the cylindrical enclosure 2 before attachment e.g. by welding (see FIG. 5).

Modifications and other variants of the described embodiments will come to mind to ones skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure.

Furthermore, although specific terms may be employed herein, they are used in a generic and descriptive sense only and not for purposes of limitation. Therefore, persons skilled in the art would recognize numerous variations to the described embodiments that would still fall within the scope of the appended claims. As used herein, the terms “comprise/comprises” or “include/includes” do not exclude the presence of other elements or steps. Furthermore, although individual features may be included in different claims (or embodiments), these may possibly advantageously be combined, and the inclusion of different claims (or embodiments) does not imply that a certain combination of features is not feasible and/or advantageous. In addition, singular references do not exclude a plurality. Finally, reference numerals in the claims are provided merely as a clarifying example and should not be construed as limiting the scope of the claims in any way.

1-25. (canceled)

26. A cylindrical secondary cell (1), comprising:
a cylindrical enclosure (2) comprising a first enclosure end (2a), a second enclosure end (2b) and an enclosure sidewall (2c) extending between the enclosure ends (2a, 2b), wherein at least one enclosure end (2b) is open;
a lid (10) to be attached radially internally to the cylindrical enclosure (2) at the open enclosure end (2b); and
an electrode roll (20) comprising a conductive sheet (21, 22),
wherein:
an end section (2ce) at the open enclosure end (2b) of the enclosure sidewall (2c) extends non-parallel to the remaining enclosure sidewall (2c),
the lid (10) comprises a flange (10f) that, when attached to the cylindrical enclosure (2), extends non-parallel to the enclosure sidewall (2c) to match the end section (2ce); and
the lid (10) is configured to be arranged in direct electrical contact with the conductive sheet (22).

27. The cylindrical secondary cell (1) of claim 26, wherein either:
the lid (10) is configured to be attached to the cylindrical enclosure (2) solely by an attachment between the flange (10f) and the end section (2ce); or
the lid (10) is configured to be attached to the cylindrical enclosure (2) by the flange (10f) being welded to the end section (2ce).

28. The cylindrical secondary cell (1) of claim 27, wherein the flange (10f) and the end section (2ce) extend substantially in parallel.

29. The cylindrical secondary cell (1) of claim 27, wherein a weld interface (30) between the flange (10f) and the end section (2ce), after welding, is at least partly visible such that the weld may be inspected.

30. The cylindrical secondary cell (1) of claim 26, wherein the end section (2ce) extends at an angle (α) to the remaining enclosure sidewall (2c).

31. The cylindrical secondary cell (1) according to claim 30, wherein the flange (10f), when attached to the cylindrical enclosure (2), extends at an angle (θ) to the enclosure sidewall (2c) and wherein the end section angle (α) matches, or essentially equals, the flange angle (θ).

32. The cylindrical secondary cell (1) of claim 26, wherein the enclosure sidewall (2c) either:
comprises a reduced radius section (2cr) from which the end section (2ce) extends; or
is S-shaped at the open enclosure end (2b).

33. The cylindrical secondary cell (1) of claim 26, wherein the flange (10f) is essentially straight.

34. The cylindrical secondary cell (1) of claim 26, wherein the lid (10), when attached to the cylindrical enclosure (2), does not protrude radially beyond the cylindrical enclosure (2).

35. The cylindrical secondary cell (1) of claim 26, wherein the lid (10) comprises at least one recessed contact portion (11) that is configured to form the direct electrical contact with the conductive sheet (22).

36. The cylindrical secondary cell (1) of claim 26, wherein the lid (10) comprises a groove or notch (12) configured to provide an opening in the lid (10) if a pressure to which the lid (10) is subjected reaches a threshold value.

37. The cylindrical secondary cell (1) of claim 36, wherein the lid (10) further comprises a recessed filling portion (13).

38. The cylindrical secondary cell (1) of claims 37, wherein the groove or notch (12) at least partially encircles the recessed filling portion (13).

39. The cylindrical secondary cell (1) of claim 26, wherein the lid (10), when attached to the cylindrical enclosure (2), is substantially axially aligned with the end section (2ce).

40. The cylindrical secondary cell (1) of claim 39, wherein the lid (10) comprises a base plane (P) that is axially aligned with the end section (2ce), when the lid (10) is attached to the cylindrical enclosure (2).

41. The cylindrical secondary cell (1) of claim 26, wherein the length of the end section (2ce) is substantially equal to the length of the flange (10f).

42. The cylindrical secondary cell (1) of claim 26, wherein the entire flange (10f) is attached to the end section (2ce), when the lid (10) is attached to the cylindrical enclosure (2).

43. The cylindrical secondary cell (1) of claim 26, wherein the first enclosure end (2a) is formed in one piece with the enclosure sidewall (2c), a positive and a negative terminal of the cylindrical secondary cell (1) are arranged at the first enclosure end (2a), the first enclosure end (2a) comprising a central terminal through-hole for one of said terminals.

44. A method of manufacturing the cylindrical secondary cell (1) of claim 26, the method comprising the step of attaching the lid (10) to the cylindrical enclosure (2) by positioning a weld where the end section (2ce) meets the flange (10f), wherein the weld is formed by a laser beam that is substantially aligned with the extension of the end section (2ce).

45. A method of manufacturing a cylindrical secondary cell (1) of claim 26, the method comprising the step of attaching the lid (10) to the cylindrical enclosure (2) by positioning a weld where the end section (2ce) meets the flange (10f), wherein the weld is formed by a laser beam that is substantially orthogonal to the extension of the end section (2ce).
